(19) United States
(12) Patent Application Publication
(10) Pub. No.: US 2018/0068405 A1
(43) Pub. Date: Mar. 8, 2018

(54) METHOD OF RECOMMENDING EDUCATIONAL PATHS TO A STUDENT AND A SITUATIONAL RESPONSE RECORDING SERVER THEREOF

(71) Applicant: Shivansh TYAGI, Bangalore (IN)

(72) Inventor: Shivansh TYAGI, Bangalore (IN)

(21) Appl. No.: 15/356,106

(22) Filed: Nov. 18, 2016

(30) Foreign Application Priority Data
Sep. 8, 2016 (IN) 201641030640

(51) Int. Cl. G06Q 50/20; G09B 7/00; G06F 17/30

(52) U.S. Cl. CPC G06Q 50/205; G06F 17/30424; G09B 7/00

(57) ABSTRACT

The present invention relates to a method of recommending educational paths to a student and a situational response recording server thereof. The method includes receiving, by the situational response recording server, at least one of a student profile and a parent profile. The method also includes providing at least one situation to the student based on the student profile and the parent profile to match a convergence criteria, the at least one situation including queries for student response, a second situation of the at least one situation including a second set of queries and being selected based on the student response to a first set of queries included in a first situation of the at least one situation. The convergence criteria is determined based on the student response in each situation. Display of at least one educational path to the student is initiated based on the convergence criteria being matched.

### CROSS-REFERENCE TO RELATED APPLICATIONS

This non-provisional application claims priority to Indian Patent Application No. 201641030640, filed on Sep. 8, 2016, which is incorporated herein by reference in its entirety.

### FIELD OF THE INVENTION

The present invention generally relates to educational paths and more particularly to a method of recommending educational paths to a student and a situational response recording server thereof.

BACKGROUND TO THE INVENTION

Growth of education has advanced due to advent of internet technology. A wide variety of education paths including courses, educational institutions, and career options are available today. For a student, especially one entering into a pre-graduate or a graduate level, there are a vast number of options to choose from based on different variables. Examples of the different variables include, but are not limited to, course type (part time or full time), institute type, industry domain, course duration, fees, prospects, and the like. Often, students and parents rely on close acquaintances, counsellors, alumni and to some extent on media to arrive at a decision to choose an education path. However, such sources are usually biased and may not be efficient in presenting appropriate education paths to suit needs and capabilities of the student. The student might hence end up in a wrong career due to the education path chosen based on such sources.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

An example of a method of recommending educational paths to a student includes receiving, by a situational response recording server, at least one of a student profile and a parent profile. The student profile corresponds to the student and the parent profile corresponds to a parent of the student. The method also includes providing, by the situational response recording server, at least one situation to the student based on the student profile and the parent profile to match a convergence criteria. The at least one situation includes one or more queries for a student response. A second situation of the at least one situation includes a second set of queries. The second situation is selected based on the student response to a first set of queries included in a first situation of the at least one situation. Further, the method includes determining, by the situational response recording server, the convergence criteria based on the student response in each situation of the at least one situation. Moreover, the method includes initiating, by the situational response recording server, display of at least one educational path to the student based on the convergence criteria being matched.

An example of a situational response recording server for profiling an institution includes a communication interface in electronic communication with at least one user device. The situational response recording server also includes a memory that stores instructions. The situational response recording server further includes a processor responsive to the instructions to receive at least one of a student profile and a parent profile. The student profile corresponds to the student and the parent profile corresponds to a parent of the student. The processor is also responsive to the instructions to provide at least one situation to the student based on the student profile and the parent profile to match a convergence criteria. The at least one situation includes one or more queries for a student response. A second situation of the at least one situation includes a second set of queries. The second situation is selected based on the student response to a first set of queries included in a first situation of the at least one situation. Further, the processor is responsive to the instructions to determine the convergence criteria based on the student response in each situation of the at least one situation. Moreover, the processor is responsive to the instructions to initiate display of at least one educational path to the student based on the convergence criteria being matched.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which:

FIG. 1 is an example representation of an environment, in accordance with an embodiment;

FIG. 2 illustrates an example flow diagram of a method for recommending educational paths to a student, in accordance with an embodiment;

FIG. 3 is an example representation of recommending educational paths to a student, in accordance with an embodiment; and

FIG. 4 illustrates a block diagram of an electronic device, in accordance with one embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

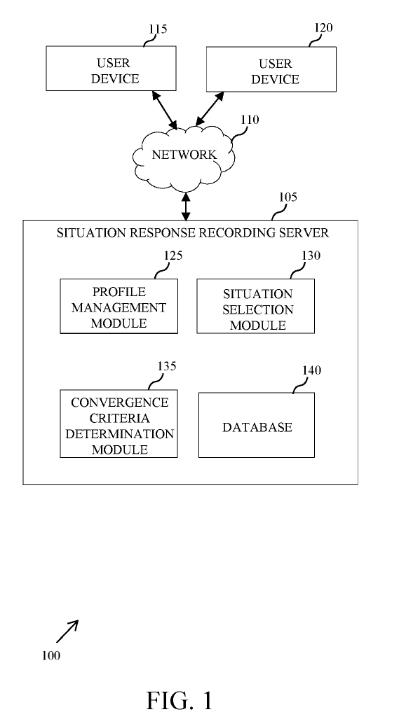

FIG. 1 is an example representation of an environment 100, in accordance with which various embodiments of the present invention are practiced. The environment 100 includes a situation response recording server 105, a network 110, and a plurality of user devices, for example a user device 115 and a user device 120. In some embodiments, the user device 115 is a student device being used by a student and the user device 120 is a parent device being used by a parent of the student. In some embodiments, the user device 115 and the user device 120 are either student devices or parent devices. The situation response recording server 105 communicates with the plurality of user devices, for example the user device 115 and the user device 120, through the network 110. FIG. 1 is explained with respect to two user devices, for example the user device 115 and the user device 120. However, it should be noted that a plurality of user devices other than the user device 115 and the user device 120 can be included in the environment 100. Examples of the user device 115 or the user device 120 include, but are not limited to, a mobile device, a computer, a tablet, a laptop, a handheld device, and the like. Examples of the network 110 includes, but are not limited to, a local area network (LAN), a wireless local area network (WLAN), a wide area network (WAN), an internet, a small area network (SAN), and the like.

The situation response recording server 105 includes a profile management module 125, a situation selection module 130, a convergence criteria determination module 135 and a situation database 140.

The profile management module 125 enables the students and the parents to create student profiles and parent profiles. In some embodiments, the students and the parents can register with the situation response recording server 105 on corresponding user devices. The profile management module 125 receives at least one of a student profile and a parent profile. The student profile corresponds to the student and the parent profile corresponds to a parent of the student. In an example, the student can create the student profile using an application or a website on the user device 115. In another example, the parent can create the parent profile using an application or a website on the user device 120.

In some embodiments, the profile management module 125 collates the student profile and the parent profile corresponding to the student. During collation, the profile management module 125 compares the student profile and the parent profile to maintain data consistency.

The situation selection module 130 provides at least one situation to the student based on the student profile and the parent profile to match a convergence criteria. The at least one situation includes one or more queries for a student response. The situation selection module 130 receives the student response. In some embodiments, the one or more queries require the student response to be one of a subjective response and an objective response, or both. The student response is further timed and recorded for the each situation. A first situation of the at least one situation includes a first set of queries and a second situation of the at least one situation includes a second set of queries. The second situation is selected based on the student response to the first set of queries included in the first situation.

The convergence criteria matching module 135 determines the convergence criteria based on the student response in each situation of the at least one situation. The convergence criteria matching module 135 determines the convergence criteria by evaluating the student response of the student at end of the each situation of the at least one situation. If the convergence criteria is unmatched for the first situation, the second situation is selected by the situation selection module 130. If the convergence criteria is matched for the student response, a set of student attributes is determined by the situation response recording server 105.

Further, the situation response recording server 105 initiates display of at least one educational path to the student if the convergence criteria is matched. The at least one educational path is displayed to the student by processing the set of student attributes and data received from one or more institutions by at least one web server (not shown in FIG. 1).

The database 140 includes the at least one situation along with the one or more queries for the student response. The situation selection module 130 selects appropriate situations with the one or more queries from the database 140. The database 140 further records the student response received from the student. Along with the student response, the database 140 also stores timing of the student response for the each situation.

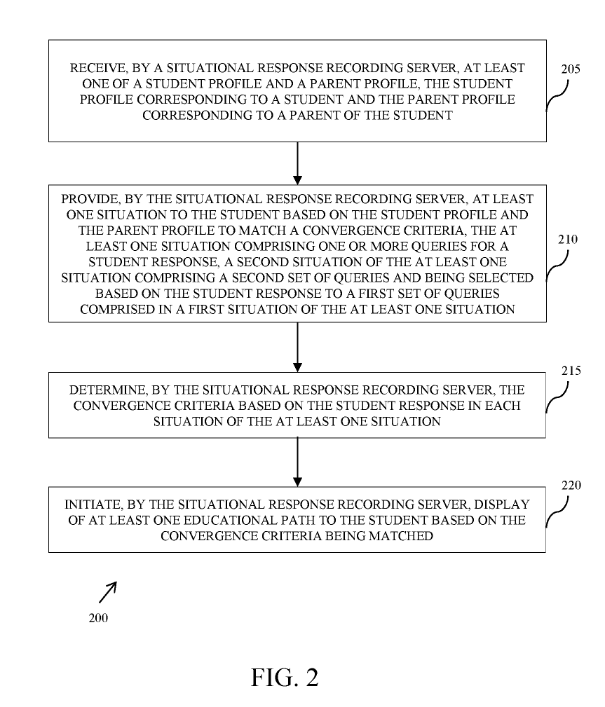

An example method for recommending educational paths to a student is explained with reference to FIG. 2.

FIG. 2 illustrates an example flow diagram of a method 200 for recommending educational paths to a student, in accordance with an embodiment. At step 205, the method 200 includes receiving at least one of a student profile and a parent profile, by a situational response recording server. In one example, the profile management module 125 of the situational response recording server 105 of FIG. 1 receives the student profile and the parent profile. The student profile corresponds to the student and the parent profile corresponds to a parent of the student.

In some embodiments, receipt of the student profile and the parent profile includes collating the student profile and the parent profile corresponding to the student by the situational response recording server. During collation, the student profile and the parent profile can further be compared to maintain data consistency.

At step 210, the method 200 includes providing, by the situational response recording server, at least one situation to the student based on the student profile and the parent profile to match a convergence criteria. In one example, the situation selection module 130 of the situational response recording server 105 of FIG. 1 provides the at least one situation to the student. The at least one situation includes one or more queries for a student response. A first situation of the at least one situation includes a first set of queries and a second situation of the at least one situation includes a second set of queries. The second situation is selected based on the student response to the first set of queries included in the first situation.

At step 215, the method 200 includes determining, by the situational response recording server, the convergence criteria based on the student response in each situation of the at least one situation. In one example, the convergence criteria matching module 135 of the situational response recording server 105 of FIG. 1 determines the convergence criteria.

In some embodiments, determining the convergence criteria includes evaluating the student response of the student at end of the each situation of the at least one situation. If the convergence criteria is unmatched for the first situation, the second situation is selected by the situation selection module. If the convergence criteria is matched for the student response, a set of student attributes is determined by the situation response recording server. Further, the at least one situation along with the one or more queries for the student response is selected from a database, for example the database 140 of FIG. 1.

In some embodiments, the student response for the one or more queries is one of a subjective response and an objective response and is stored in the database. The student response is further timed and recorded for the each situation of the at least one situation in the database.

At step 220, the method 200 includes initiating, by the situational response recording server, display of at least one educational path to the student based on the convergence criteria being matched. The at least one educational path is displayed to the student by processing the set of student attributes and data received from one or more institutions by at least one web server.

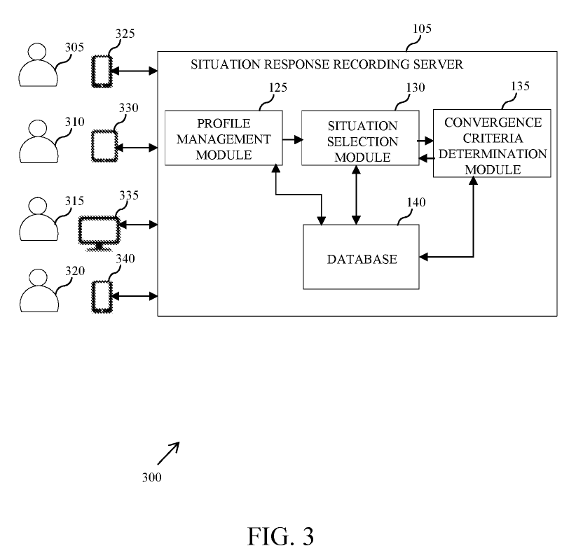

Referring now to FIG. 3, an example representation of recommending educational paths to a student is illustrated, in accordance with an embodiment.

FIG. 3 is an example representation 300 recommending educational paths to a student, in accordance with one embodiment. The example representation 300 includes one or more students, for example a student 305 and a student 310, and one or more parents, for example a parent 315 and a parent 320. The example representation 300 further includes a mobile phone 325, a tablet 330, a desktop 335, a mobile phone 340, and the situation response recording server 105.

The parent 315 is a parent of the student 305 and the parent 320 is a parent of the student 310. Each student (for example the student 305 or the student 310) can be associated with one or more student devices (for example, the mobile phone 325 or the tablet 330, respectively). Each student can register with the situation response recording server 105 (for example, by using an application or a website on the student devices) and create a student profile through corresponding student devices. The student profiles are uploaded to the situation response recording server 105 and managed by the profile management module 125. The students can enter details including, but not limited to, extracurricular activities, academic performance, co-curricular activities, cultural background, personal habits, hobbies, and the like.

Similarly, each parent (for example the parent 315 or the parent 320) can be associated with one or more parent devices (for example, the desktop 335 or the mobile phone 340, respectively). Each parent can register with the situation response recording server 105 (for example, by using the application or the website on the parent devices) and create a parent profile through corresponding parent devices. The parent profiles are uploaded to the situation response recording server 105 and managed by the profile management module 125. The parents can enter details including, but not limited to, family background, occupations, finances, and the like.

The profile management module 125 further collates the student profiles of the student 305 and the student 310 with the parent profiles of the parent 315 and the parent 320, respectively. During collation, the profile management module 125 compares the student profile of the student 305 and the parent profile 125 of the parent 315 to maintain data consistency.

The situational response recording server 130 provides a first situation to the student 305 based on the student profile of the student 305 and the parent profile of the parent 315 of the student 305 to match a convergence criteria. The first situation includes a first set of queries, for example query 1 to query N. Each query requires the student 305 to respond with either subjective response or objective response. Each student response is recorded in the database 140 along with time taken to answer each query, if the student 305 has skipped to answer any query, and the like.

The student response for the first situation is evaluated and matched with the convergence criteria by the convergence criteria determination module 135. If the student response of the first situation does not match the convergence criteria, a second situation is selected from the database 140 based on the student response. The second situation including a second set of queries is provided to the student 305. The convergence criteria at end of the second situation is again evaluated. If the convergence criteria is matched, a set of student attributes are determined else another situation is selected.

If the convergence criteria is matched, the situational response recording server 130 initiates display of at least one educational path to the student. The at least one educational path is displayed to the student by processing (by the situational response recording server 130) the set of student attributes and data from one or more institutions by at least one web server. For instance, the student is displayed with a recommendation list of one or more courses, at least one or more entrance exams the student 305 can give, a list of colleges including predicted performance, the at least one or more colleges including one or more courses and a predicted education paths.

In one instance, the recommendation list can include one or more types of courses for example, primary courses, secondary courses and tertiary courses as per the student attributes and the data from the institutions. The student 305 can select any of the courses and view the one or more entrance exams that can be given for the same. The list of colleges is based on predicted performance of the entrance exams. The predicted performance is further classified into exceeding predicted performance, meeting predicted performance and below predicted performance.

If performance of the student 305 exceeds the predicted performance, information of college 1 is displayed as an educational path for the student. If the performance of the student 305 meets the predicted performance, information of college 2 would be displayed as the at least one educational path for the student. If the performance of the student 305 is below the predicted performance, information of college 3 would be displayed as the at least one educational path for the student. Based on performance of the student 305, the colleges would be displayed to the student in a decreasing order from a merit point of view of the colleges along with one or more types of courses.

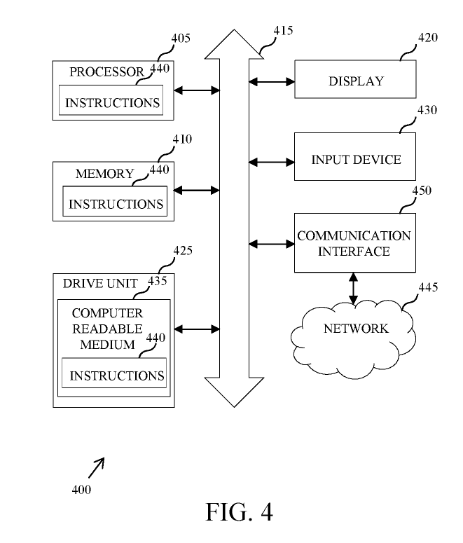

Referring to FIG. 4, a block diagram of an electronic device 400 is illustrated, which is representative of a hardware environment for practicing the present invention. The electronic device 400 can include a set of instructions that can be executed to cause the electronic device 400 to perform any one or more of the methods disclosed. The electronic device 400 may operate as a standalone device or can be connected, for example using a network, to other electronic devices or peripheral devices.

In a networked deployment of the present invention, the electronic device 400 may operate in the capacity of a user device, for example the user device 115 or the user device 120, a situation response recording server, for example the situation response recording server 105 of FIG. 1, in a server-client user network environment, or as a peer electronic device in a peer-to-peer (or distributed) network environment. The electronic device 400 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single electronic device 400 is illustrated, the term “device” shall also be taken to include any collection of systems or sub-systems that individually or jointly execute a set, or multiple sets, of instructions to perform one or more computer functions.

The electronic device 400 can include a processor 405, for example a central processing unit (CPU), a graphics processing unit (GPU), or both. The processor 405 can be a component in a variety of systems. For example, the processor 405 can be part of a standard personal computer or a workstation. The processor 405 can be one or more general processors, digital signal processors, application specific integrated circuits, field programmable gate arrays, servers, networks, digital circuits, analog circuits, combinations thereof, or other now known or later developed devices for analyzing and processing data. The processor 405 can implement a software program, such as code generated manually (for example, programmed).

The electronic device 400 can include a memory 410, such as a memory 410 that can communicate via a bus 415. The memory 410 can include a main memory, a static memory, or a dynamic memory. The memory 410 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 410 includes a cache or random access memory for the processor 405. In alternative examples, the memory 410 is separate from the processor 405, such as a cache memory of a processor, the system memory, or other memory. The memory 410 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 410 is operable to store instructions executable by the processor 405. The functions, acts or tasks illustrated in the figures or described can be performed by the programmed processor 405 executing the instructions stored in the memory 410. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 400 can further include a display unit 420, for example a liquid crystal display (LCD), an organic light emitting diode (OLED), a flat panel display, a solid state display, a cathode ray tube (CRT), a projector, a printer or other now known or later developed display device for outputting determined information. The display 420 can act as an interface for a user to see the functioning of the processor 405, or specifically as an interface with the software stored in the memory 410 or in a drive unit 425.

Additionally, the electronic device 400 can include an input device 430 configured to allow the user to interact with any of the components of the electronic device 400. The input device 430 can include a stylus, a number pad, a keyboard, or a cursor control device, for example a mouse, or a joystick, touch screen display, remote control or any other device operative to interact with the electronic device 400.

The electronic device 400 can also include the drive unit 425. The drive unit 425 can include a computer-readable medium 435 in which one or more sets of instructions 440, for example software, can be embedded. Further, the instructions 440 can embody one or more of the methods or logic as described. In a particular example, the instructions 440 can reside completely, or at least partially, within the memory 410 or within the processor 405 during execution by the electronic device 400. The memory 410 and the processor 405 can also include computer-readable media as discussed above.

The present invention contemplates a computer-readable medium that includes instructions 440 or receives and executes the instructions 440 responsive to a propagated signal so that a device connected to a network 445 can communicate voice, video, audio, images or any other data over the network 445. Further, the instructions 445 can be transmitted or received over the network 445 via a communication port or communication interface 450 or using the bus 415. The communication interface 450 can be a part of the processor 405 or can be a separate component. The communication interface 450 can be created in software or can be a physical connection in hardware. The communication interface 450 can be configured to connect with the network 445, external media, the display 420, or any other components in the electronic device 400 or combinations thereof. The connection with the network 445 can be a physical connection, such as a wired Ethernet connection or can be established wirelessly as discussed later. Likewise, the additional connections with other components of the electronic device 400 can be physical connections or can be established wirelessly. The network 445 can alternatively be directly connected to the bus 415.

The network 445 can include wired networks, wireless networks, Ethernet AVB networks, or combinations thereof. The wireless network can include a cellular telephone network, an 802.11, 802.16, 802.20, 802.1Q or WiMax network. Further, the network 445 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 400.

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

Various embodiments disclosed herein provide numerous advantages by providing a method for recommending educational paths to a student and a situational response recording server thereof. The present invention provides a student with education paths according to a set of attributes determined exclusively for the student. The student is further free to choose the best education path.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A method of recommending educational paths to a student, the method comprising:
receiving, by a situational response recording server, at least one of a student profile and a parent profile, the student profile corresponding to the student and the parent profile corresponding to a parent of the student;
providing, by the situational response recording server, at least one situation to the student based on the student profile and the parent profile to match a convergence criteria, the at least one situation comprising one or more queries for a student response, a second situation of the at least one situation comprising a second set of queries and being selected based on the student response to a first set of queries comprised in a first situation of the at least one situation;
determining, by the situational response recording server, the convergence criteria based on the student response in each situation of the at least one situation; and
initiating, by the situational response recording server, display of at least one educational path to the student based on the convergence criteria being matched.

2. The method as claimed in claim 1, wherein receiving the at least one of the student profile and the parent profile comprises:
collating, by the situational response recording server, the student profile and the parent profile corresponding to the student.

3. The method as claimed in claim 2, wherein collating the at least one of the student profile and the parent profile comprises:
comparing, by the situational response recording server, the student profile and the parent profile to maintain data consistency.

4. The method as claimed in claim 1, wherein the student response for the one or more queries are one of a subjective response and an objective response, further wherein the student response is timed and recorded for the each situation of the at least one situation in a database.

5. The method as claimed in claim 4, wherein determining the convergence criteria comprises:
evaluating, by the situational response recording server, the student response of the student at end of the each situation of the at least one situation.

6. The method as claimed in claim 5 further comprising:
determining, by the situational response recording server, a set of student attributes based on the convergence criteria being matched for the student response.

7. The method as claimed in claim 1 further comprising:
selecting, by the situational response recording server, the second situation based on the convergence criteria being unmatched for the first situation.

8. The method as claimed in claim 1, wherein the each situation of the at least one situation comprising the one or more queries for the student response is selected from a database.

9. The method as claimed in claim 6, wherein the at least one educational path is displayed to the student by processing the set of student attributes and data from one or more institutions by at least one web server.

10. A situational response recording server for recommending educational paths to a student, the situational response recording server comprising:
a communication interface in electronic communication with at least one user device;
a memory that stores instructions; and
a processor responsive to the instructions to:
receive at least one of a student profile and a parent profile from the at least one user device, the student profile corresponding to the student and the parent profile corresponding to a parent of the student;
provide at least one situation to the student based on the student profile and the parent profile to match a convergence criteria, the at least one situation comprising one or more queries for a student response, a second situation of the at least one situation comprising a second set of queries and being selected based on the student response to a first set of queries comprised in a first situation of the at least one situation;
determine the convergence criteria based on the student response in each situation of the at least one situation; and
initiate display of at least one educational path to the student based on the convergence criteria being matched.

11. The situational response recording server as claimed in claim 10, wherein the processor is further responsive to the instructions to receive the at least one of the student profile and the parent profile by collating the student profile and the parent profile corresponding to the student.

12. The situational response recording server as claimed in claim 11, wherein the processor is further responsive to the instructions to collate the at least one of the student profile and the parent profile by comparing the student profile and the parent profile to maintain data consistency.

13. The situational response recording server as claimed in claim 10, wherein the student response for the one or more queries are one of a subjective response and an objective response, further wherein the student response is timed and recorded for the each situation of the at least one situation in a database.

14. The situational response recording server as claimed in claim 13, wherein the processor is further responsive to the instructions to determine the convergence criteria by evaluating the student response of the student at end of the each situation of the at least one situation.

15. The situational response recording server as claimed in claim 14 wherein the processor is further responsive to the instructions to determine a set of student attributes based on the convergence criteria being matched for the student response.

16. The situational response recording server as claimed in claim 10 wherein the processor is further responsive to the instructions to select the second situation based on the convergence criteria being unmatched for the first situation.

17. The situational response recording server as claimed in claim 10, wherein the each situation of the at least one situation comprising the one or more queries for the student response is selected from a database.

18. The situational response recording server as claimed in claim 15, wherein the at least one educational path is displayed to the student by processing the set of student attributes and data from one or more institutions by at least one web server.
